(19) United States
(12) Patent Application Publication
(10) Pub. No.: US 2020/0090141 A1
(43) Pub. Date: Mar. 19, 2020

(54) SYSTEM AND METHOD FOR REGULARLY DISTRIBUTING GRANULAR RESOURCES USING TIMEFRAMES

(71) Applicant: Grace Tang, Santa Clara, CA (US)

(72) Inventor: Grace Tang, Santa Clara, CA (US)

(21) Appl. No.: 16/132,429

(22) Filed: Sep. 16, 2018

(51) Int. Cl. G06Q 20/06; G06Q 50/26; G06Q 20/32

(52) U.S. Cl. CPC G06Q 20/0652; G06Q 20/32; G06Q 50/26

(57) ABSTRACT

This invention relates generally to a system and method for managing and packaging resources, regularly distributing granular resources to individuals among groups of people, allowing individuals to receive said granular resources upon request in each timeframe. Enable said granular resources to synchronize with time, expire at the end of each timeframe. Enable said system to automatically refresh itself, start a new timeframe immediately after the previous timeframe ends, continuously and repeatedly distribute said resources to said groups of people in each timeframe.

This application is a continuation-in-part of Application No. 62/423,778, filed 2016 Nov. 18, by the present inventor, that are incorporated by reference.

### BACKGROUND OF THE INVENTION

### 1. Field of the Invention

This invention relates generally to a system and method for managing and packaging resources, regularly distributing granular resources to individuals among groups of people, allowing individuals to receive said granular resources upon request in each timeframe. Enable said granular resources to synchronize with time, expire at the end of each timeframe. Enable said system to automatically refresh itself, start a new timeframe immediately after the previous timeframe ends, continuously and repeatedly distribute said resources to said groups of people in each timeframe.

### 2. Description of Prior Art

Our human society is formed by individual human beings. Each person consumes resources to live, and produces various outputs every single day. Depends on the circumstance of a human being, a person may produce high quality work to contribute to our society; or a person may produce violence and causes injury to other people.

If we regard each individual human being as a unit, there is an input and output for each unit. A person needs to have food and shelter to stay alive, this is the basic needs of a human being. If such needs are not met, or if a person feels threatened or unsafe in our society, he/she will react in a negative way, which means, he/she may have negative outputs to our society. However, when a person's basics needs are met, when he/she feels safe and appreciated by our society, he/she will contribute positive outputs to our society.

An human being is an entity, he/she consumes goods and services from our society, this is the input of that person. He/she produces goods and services for our society, this is the output of said person. This constant input and output of said person creates the unit economy or micro-economy that surrounds said person (FIG. 2).

What is group economy? A group of people is formed by multiple human beings. Their combined consumption of goods and services from our society is the input of said group of people. Their combined contribution and/or production of goods and services for our society is the output of said group of people (FIG. 3).

What is global economy? Global economy is the aggregation of all human beings' consumption of goods and services from our society, and contribution of goods and services into our society. It is summation of all these people's inputs and outputs. It is a transient term, it is a constant movement of the resources in our society. It is like wind, wind only exists when there is movement of the air. Without the movement, there is no transfer of the air, there is no wind.

The power of the economy can not be contained in a box, the power of the economy can only be fully released when everyone in our society is actively involved in the making and contributing to our society, the power of the economy can only be sustained when everyone in our society have their basic needs met, when they are not starved or homeless, then they can contribute to our society in a positive way.

How to achieve this?

It is in the nature of energy to disperse itself. It is in the nature of wind to constantly moves around. For economy, its nature is to constantly transfer resources through the inputs and outputs of each individual human beings. A living economy is an economy that ensures every member of our human society are actively involved in contributing to our society, and having their everyday needs met.

What is movement? What does transient mean? It means that an entity changes its state over time. In order to create this constant transfer of energy, it has to synchronize with time.

Have you ever wondered why there are four seasons in nature? Why the sun rises and sets? Why the tide in the ocean comes in and out? Because they are synchronized with time. Without this synchronization with time, without this movement, there is no life.

Money, gold, diamond and etc are the media that we currently use in our society to transfer resources. These are tangible assets for storing and retaining value for an unlimited period of time. But they are not transient, they are not synchronized with time.

In order to properly transfer resources in our human society, this media needs to synchronize with time. To create an fully energized economy, this new media needs to be transient and synchronize with time. I named it Time Token or the Raindrop Token.

Why do we breathe? We breathe because human cells require oxygen to use food energy efficiently and to release the carbon dioxide generated by that use.

Why do plants need water? During photosynthesis, plants take in carbon dioxide and water, disassemble the molecules and convert them into sugar and oxygen. The water molecules are split into hydrogen and oxygen, and the hydrogen joins carbon dioxide to create sugars.

Air and water are the most common things around us. Water covers 71% of earth and we are surrounded with air. Without either of them, we won't live. We need these basic elements to create energy for our cells, to stay alive.

Like water and air, we need abundant time tokens as basic elements in our society. It brings energy to a person, helping he/she gets the resources that he/she needs at that moment, so that he/she can work, live and pursuit his/her purpose in life, create real assets and contributes to our society. Like a plant needs rain to pursuits its purpose in life to live, grow and blossom; time token brings resources to us to meet our basic needs, helping us to create our own assets using our lives, using our time.

Time token is different from the traditional money. The traditional money is good at retaining and storing assets, but lacks the features for easy, quick, frictionless dispersement, which are the fundamental characteristics of energy. The traditional money is timeless, it does not synchronize with time.

Time token if a new form of cryptocurrency. When adding timestamp and expiration date into cryptocurrency, if a time token is not received and consumed by a person, it expires by the end of the day, or by the end of the timeframe set for said time token.

It is like a raindrop drops onto the soil, if it does not get absorbed by the plants on the ground, it gets absorbed into the soil, or vaporize after the sun comes out.

Because time token has an expiration date, the person who receives it will try to make the best use of the resource and the energy it brings when they can, before the token expires. No one can withhold this cryptocurrency beyond its timeframe. No one wants to accumulate this cryptocurrency beyond what they can consume in that timeframe. It holds transient energy, it holds temporary resource, it is beyond the scope of traditional money.

Time token is used to disperse resources among the people in our society, so that everyone have immediate, instant, frictionless access to the resources to meet their needs. Time token will allow people to receive the energy and resource when they need it, so that they can use their creativity, talent and expertise to create real assets and contribute to human society. It is following the true nature of a transient media, to transfer and deliver energy among human beings.

The future of work is changed because of this. When implemented correctly, human beings will no longer has to work just to stay alive. Instead, we will be able to choose to do meaningful works, using our creativity, talent and expertise to contribute to our society, to bring real assets to human society. Like a flower choose to live, grow and blossom, each human beings has his/her basic instinct to live, grow and work, to do what we are designed to achieve in this world, truly live and fulfill the purpose of our lives.

### SUMMARY OF THE INVENTION

This invention relates generally to a system and method for managing and packaging resources, regularly distributing granular resources to individuals among groups of people, allowing individuals to receive said granular resources upon request in each timeframe. Enable said granular resources to synchronize with time, expire at the end of each timeframe. Enable said system to automatically refresh itself, start a new timeframe immediately after the previous timeframe ends, continuously and repeatedly distribute said resources to said groups of people in each timeframe.

### BRIEF DESCRIPTION OF THE DRAWINGS

FIG. 1 shows an illustration of layers of human needs.

FIG. 2 shows an illustration of the unit economy of one person.

FIG. 3 shows an illustration of the group economy of a group of people.

FIG. 4 shows an illustration of a system regularly distribute a plurality of granular resources to individuals using time tokens, according to one embodiment of the invention.

FIG. 5 shows an illustration of a system regularly distribute a plurality of granular resources to individuals using time tokens, by receiving said time tokens, said individuals produce real assets represented as custom tokens, according to one embodiment of the invention.

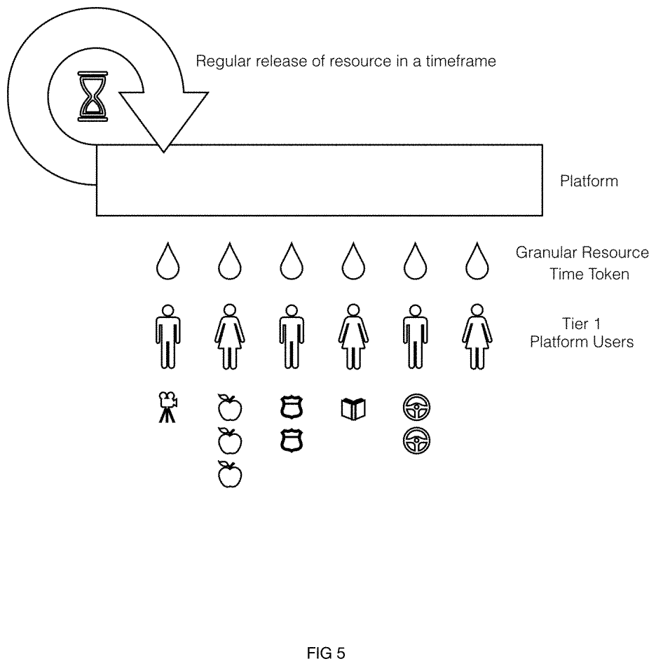

FIG. 6 shows an illustration of a system regularly distribute a plurality of granular resources to individuals using time tokens, by receiving said time tokens, said individuals produce real assets represented as custom tokens, and said custom tokens are accepted and received by other people, according to one embodiment of the invention.

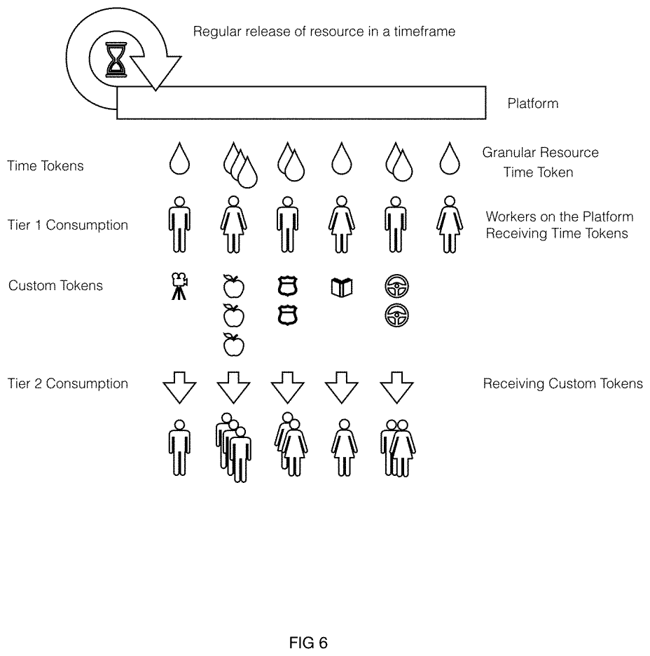

FIG. 7 shows an illustration of a system regularly distribute a plurality of granular resources to individuals using time token, said individuals produce real assets represented as custom tokens, and said custom tokens are received by other people, and said production and receiving of custom tokens continue through a plurality of tiers of people, according to one embodiment of the invention.

FIG. 8 shows an illustration of the structure of a time token, according to one embodiment of the invention.

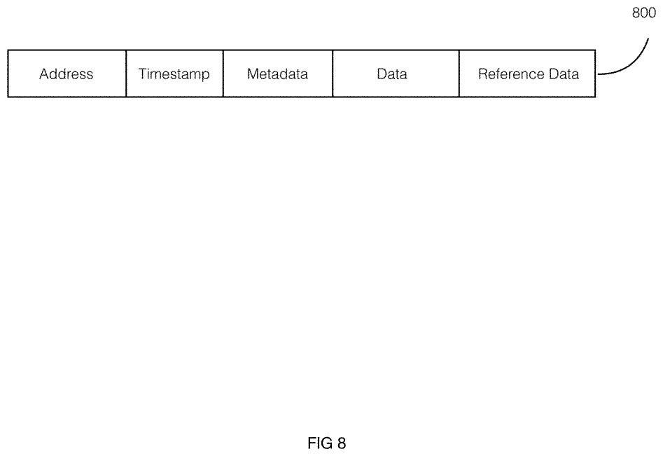

FIG. 9 is a flowchart that shows sequence of process of a time token system regularly distribute a plurality of granular resources to individuals, allow said individuals to receive said granular resources upon request in each timeframe, according to one embodiment of the invention.

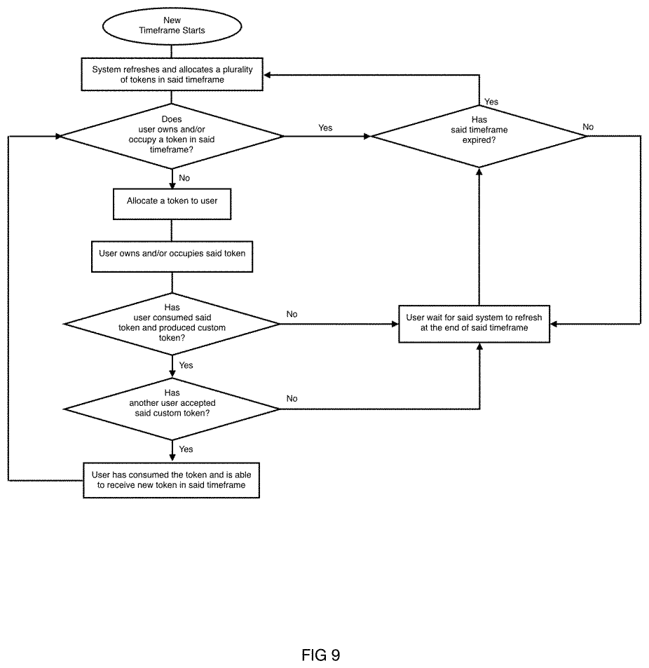

FIG. 10 is a flowchart that shows sequence of process of a time token system regularly distribute a plurality of granular resources to an individual, allow said individual to receive new time token within said timeframe, when he/she produces custom token and said custom token is accepted and received by other people, according to one embodiment of the invention.

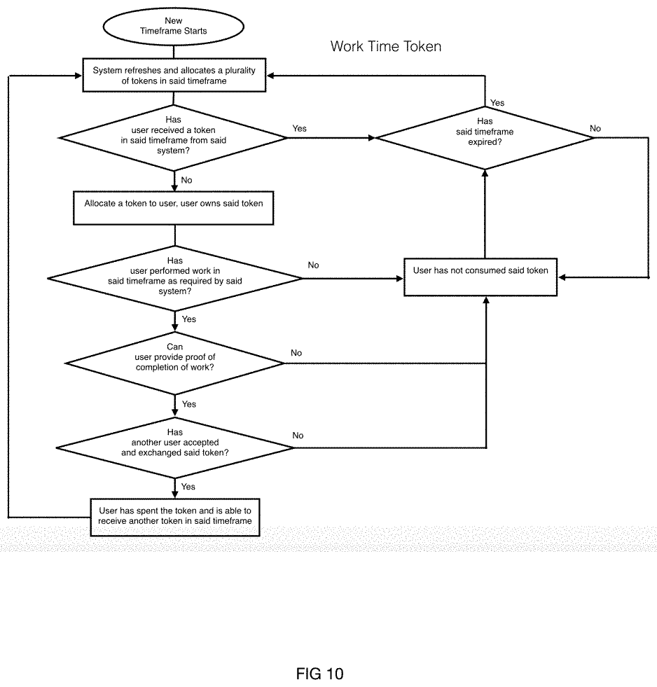

FIG. 11 is a flowchart that shows sequence of process of a time token system regularly distribute a plurality of pre diem work time token to an individual, allowing said individual to redeem said work time token upon verification of the completion of work, according to one embodiment of the invention.

FIG. 12 shows an illustration of a park implementing the time token system, allowing people to exchange work time token for occupancy time token of the house situated in said park, according to one embodiment of the invention.

FIG. 13 shows an illustration of a park implementing the time token system using a smart phone, allowing people to exchange work time token for occupancy time token of the house situated in said park, according to one embodiment of the invention.

FIG. 14 is a block diagram of a time token system according to one embodiment of the invention.

FIG. 15 shows an illustration of an implementation of the time token system using smart phone, allowing people to exchange values using coffee time token and tailor time token, according to one embodiment of the invention.

FIG. 16 shows an illustration of a peer custom design system regularly distribute a plurality of granular resources to its users using time tokens, by receiving said time tokens, said users produce real assets represented as custom tokens, according to one embodiment of the invention.

### DETAILED DESCRIPTION OF THE INVENTION

This invention relates generally to a system and method for managing and packaging resources, regularly distributing granular resources to individuals among groups of people, allowing individuals to receive said granular resources upon request in each timeframe. Enable said granular resources to synchronize with time, expire at the end of each timeframe. Enable said system to automatically refresh itself, start a new timeframe immediately after the previous timeframe ends, continuously and repeatedly distribute said resources to said groups of people in each timeframe.

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

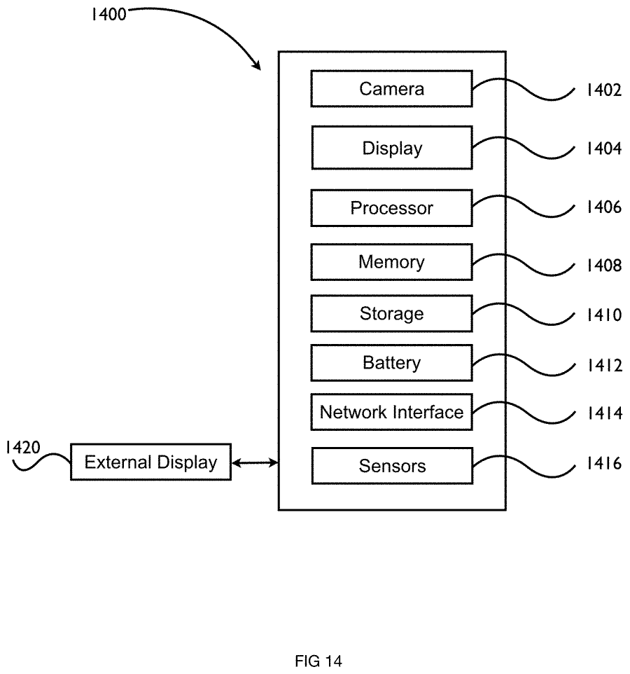

With reference to FIG. 14, in its most basic configuration, the time token system 1400 comprises at least one processing unit or processor 1406 and system memory 1408, a display 1404, a camera and/or video camera 1402, a storage unit 1410 and network interface 1414. In embodiments, an application program is loaded into the memory 1408 of the system and executed by the system processor 1406, the system receives data through network interface 1414, store said data in system storage 1410, process and manage said data using the application program in the memory 1408, and display them in an iterative way on the system display 1404. Said system may has a plurality of external displays and/or devices 1420.

Depending on the exact configuration and type of time token system 1400, memory 1408 may be volatile (such as RAM), non-volatile (such as ROM, flash memory, etc.), or some combination of the two.

An embodiment of time token system 1400 is a wireless touch screen device, such as a smart phone, a tablet, a mobile device and other devices with similar characteristics including a smart TV.

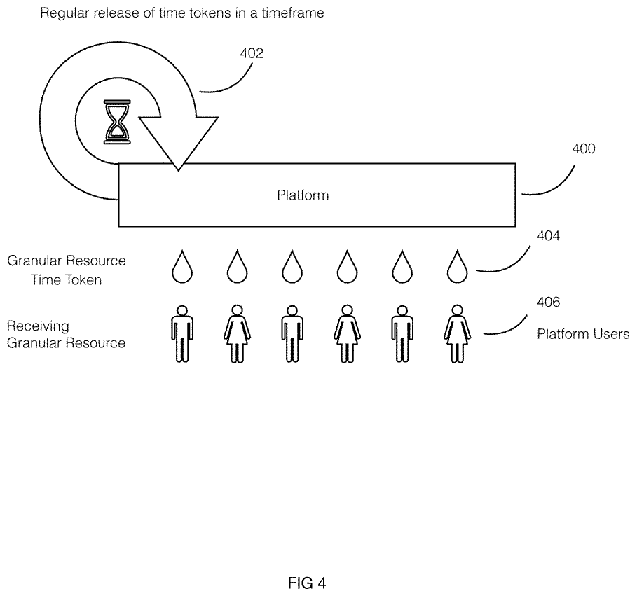

As shown in FIG. 4, a platform 400 automatically issues a plurality of time tokens 404 in a predetermined timeframe 402.

Within said timeframe, each user 406 of said platform can request and instantly receives a time token 404.

A predetermined value is instilled into each time token 404, contains a granular amount of resource, which can be released to said user within said timeframe 402.

Each time token is valid and functional within said timeframe, and immediately expires at the end of said timeframe 402.

At the end of each timeframe 402, said system automatically refresh, starts a new timeframe, and issues a new set of time tokens.

Said system counts the time, resets and starts a new timeframe at the end of each timeframe, issues new time tokens in each timeframe, continuously and automatically distributes time tokens to users who request them.

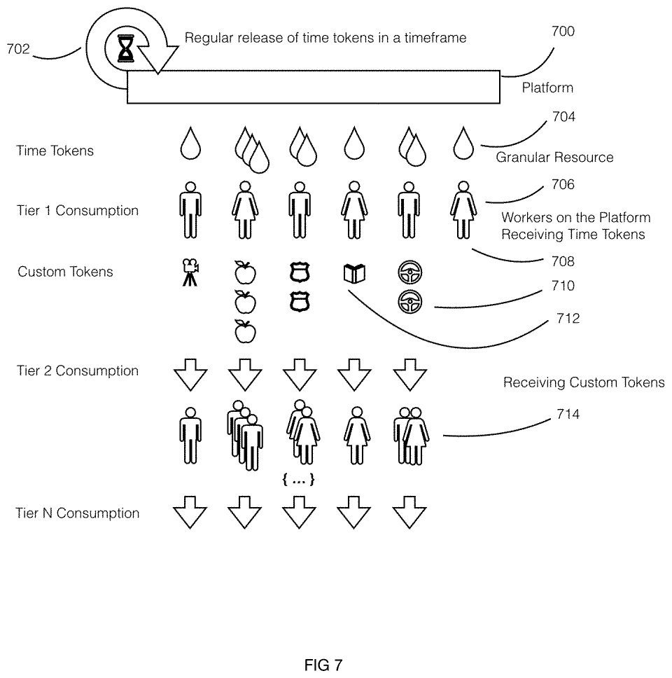

As shown in FIG. 7, a platform 700 automatically issues a plurality of time tokens 704 in a timeframe 702.

Within said timeframe, users 706 of said platform can request and instantly receive time token 704.

A predetermined value is instilled into each time token 704, contains a granular amount of resource, which can be released to said user within said timeframe 702.

Each time token is valid and functional within said timeframe, and immediately expires at the end of said timeframe.

At the end of each timeframe 702, said system automatically refresh, and issues a new set of time tokens.

Said system counts the time, resets at the end of timeframe, immediately starts a new timeframe, issues new time tokens, continuously and automatically distributes time tokens to users who request them.

Said users 706 receive the time tokens, use the transient resources stored in the time tokens, produce new assets, represent them as custom tokens 710, register them on the blockchain system. By registering and validating these custom token on the blockchain system, they encode the creation, ownership and attributes of these custom token and have them publicly recognized by the blockchain system.

For example, a writer receives and consumes a time token 704. Using the resource allocated in said time token, said writer purchases food to eat. She works on her book on that day, and produces a new chapter of said book. She creates a custom token for said new chapter of her book, includes her author information, attributes, readership price and other information into the metadata part of said custom token 800, encrypt it and registered it on the blockchain system. She can then sell the readership of that chapter and receive payments for her work using said custom token 712.

A custom token created by human beings can be a token that expires after a predetermined timeframe, or they can be a real asset and don't have any expiration date. Like diamond, gold and/or traditional money, a custom token created by human beings through their work can be valued as real assets, exchange with other real assets, and may last forever. For example, an artist created an oil painting and use a custom token to register its ownership. Said old painting is a real asset, and can be exchanged with other real assets like money or gold.

The custom tokens created by human beings can be exchanged into other tokens or real assets, consumed by other human beings, or transferred to other human beings. This is illustrated in FIG. 7 as Tier 2 to Tier N consumption 714.

As another example, a women receives a time token and rest the whole day 708. She does not produce any work nor create any custom token on that day 708. In that case, she consumes the time token when it expires at the end of said timeframe.

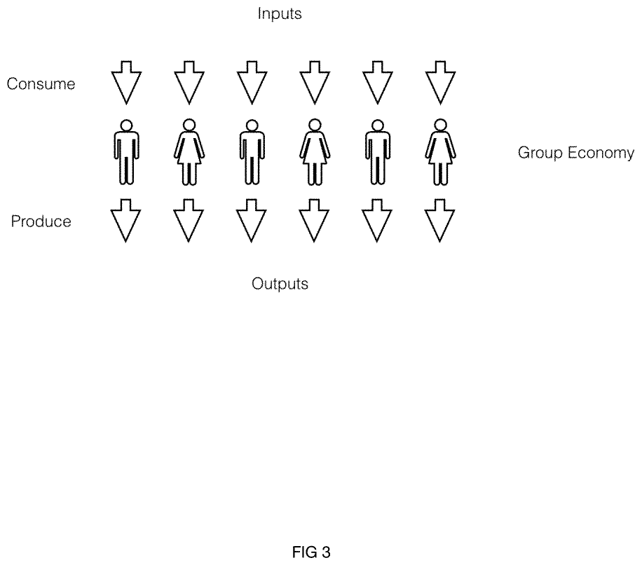

As shown in FIG. 3, consumption itself is a necessary function in our economy. Since the time token has an expiration date, the consumption of said token is guaranteed at the end of its timeframe. A balanced economy requires equal amount of consumption and production. For the time token system, since each timeframe creates sufficient time tokens for all users, all consumption needs are met on said system, and all unconsumed tokens expires at the end of each timeframe. Time token system maintains a perfect balance between the production and consumption on said system.

A person choose to work because working provides more opportunities and long term benefits.

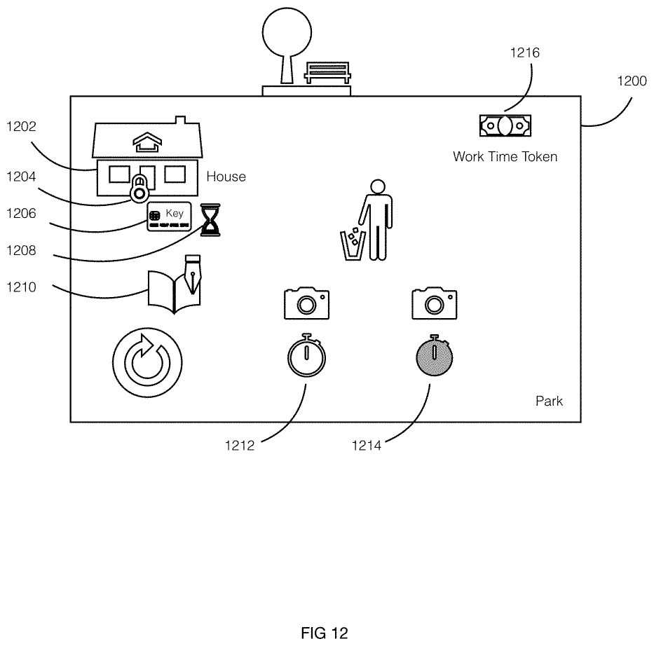

An example of an implementation of said system is shown in FIG. 12. An house is situated in a public park. Said park needs people to maintain it and keep the area clean. Homeless people sleeps in the park from time to time.

Using the time token, a solution is created to keep said park clean and solve the homeless issue.

Said park 1200 installs a time token system issues work time tokens at park every day. People who visit the park can claim and receive a token. Upon receiving a token, said person takes a picture of the park before he/she perform the work 1212, then take pictures of him/her performing the work cleaning up the park. After work is completed, said person record a short video of he/she summarizing his/her work completed 1214 at the park. Said person then register his/her work on the work log 1210, and sign the work log. Upon receiving the registered work, said system automatically issues a temporary key 1206, which allows the worker to open the lock 1204, access and use the house 1202 within the next 24 hours 1208. The work token claimed by said person are now redeemed and consumed.

Said system refresh itself automatically in 24 hours. The temporary key 1206 expires and the person will need to perform the work again in order to regain access to the house.

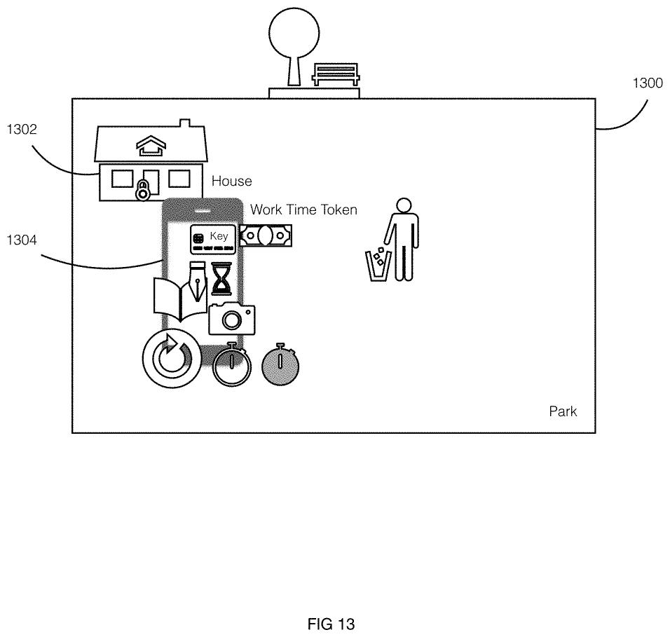

As illustrated in FIG. 13, a smart phone is used to implement said time token system 1304. Said smart phone is wirelessly connected with the lock of said house 1302. Said time token system issues a polarity of work time tokens each day, record the work being performed at the park, send the reports to the management group of the park when completion of work is registered, validate and issue temporary access to the house for the workers.

In this solution, the cost of keeping said park clean and giving homeless people a place to live, is simply a smartphone and the mechanism of work time token.

The above implementation is illustrated here only to serve as an example of the simplicity of implementing the mechanism of time token.

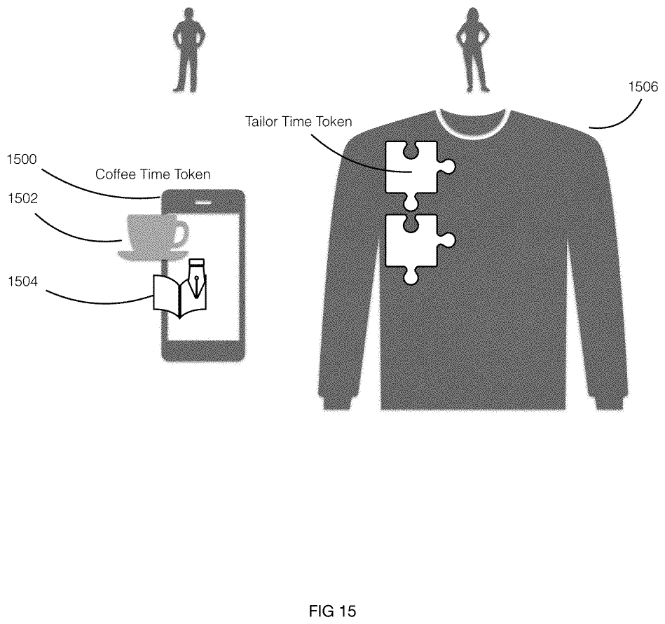

As illustrated in FIG. 15, a smart phone is used to implement a time token system 1500. Jane is a tailor, she sells custom clothing. Jack lives downstairs, he owns a coffee shop. Jack uses time token system to issues coffee time tokens every day. Jane uses time token system to issues tailor time tokens every day. Both types of tokens have the expiration period of one year. Jack orders a custom shirt from Jane at the cost of 30 tailor time tokens. Jane exchange these tokens with Jack for 30 coffee time tokens. Jane gets one cup of coffee from Jack's shop every day, by the end of 30 days, she has consumed all 30 coffee time tokens. She completed the custom shirt 1506 for Jack and delivered it to Jack. This example shows that time token system can be used to divide a task into granular unit of time tokens and make exchangeable and tradable.

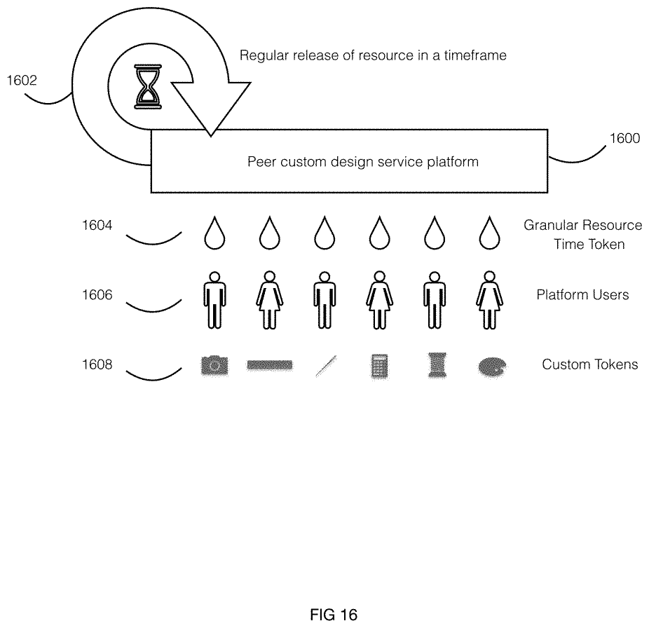

FIG. 16 shows an illustration of a peer custom design system 1600 regularly distribute a plurality of granular resources to its users 1606 using time tokens 1604, by receiving said time tokens, said users produce real assets represented as custom tokens 1608, according to one embodiment of the invention.

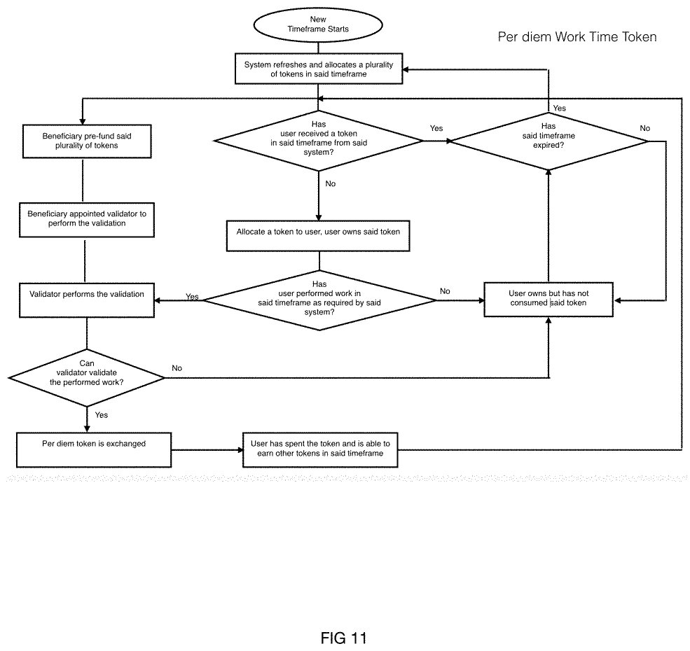

FIG. 11 is a flowchart that shows sequence of process of a time token system regularly distribute a plurality of pre diem work time token to an individual, allowing said individual to redeem said work time token upon verification of the completion of work. When implementing said process in the peer custom design system 1600 as illustrated in FIG. 11, said peer custom design system 1600 automatically verifies completed work, redeeming said work time token and reward user upon said user reporting completion of work.

Like raindrops, time token is simple and straight forward. Time token is a transient container of resource. Because it expires in a predetermined timeframe, people only claim it when they have the need to use its value, there is no need to claim more tokens than what one needs. Because it is easily accessible, anyone who needs it can claim time token and uses the transient resource to fulfill their needs. This will provide trust, stability and assurance in our society.

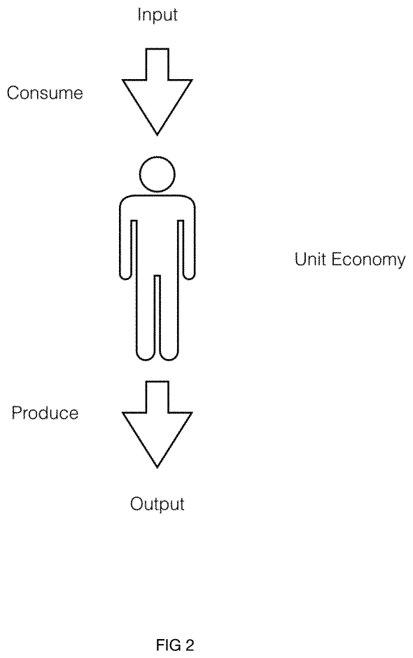

Time token can be implemented in various scopes. As illustrations in FIG. 2, FIG. 3 and FIG. 4, Time token system is functional in either unit economy, group economy, regional economy or global economy.

Rain brings water to the ground, wherever it rains, the ground flourish. Likewise, systems that implement the time token mechanism bring abundant resources to their users, and people shall thrive on said systems.

What's the impact of time token to traditional monetary system? Our tradition monetary system uses tangible assets such as gold, diamond and money to represent and protect the ownership of real assets, that will not change.

In nature, lake and ocean contain a vast amount of water, rain brings and distributes water. Each elements in nature has its role. Time token brings and distributes resources to human beings, enable them to use their creativity, talent and expertise to create real assets, store the value in real assets using traditional monetary system.

Does the river, lake and ocean welcome rain? Does the land welcome rain? Yes, rain brings resource and energy to the land, river, lake and ocean, it brings life to this world. Rain has an important role in our environment.

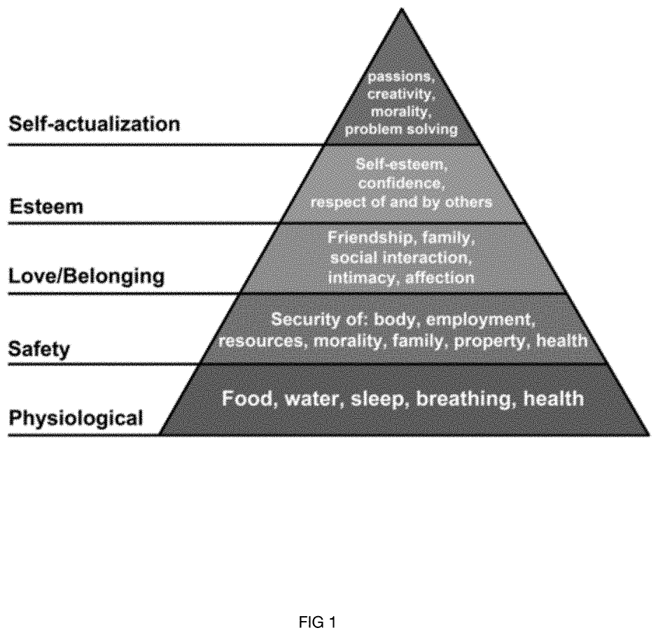

When there are abundant time tokens made easily accessible, available to claim and use in our society, people will have the opportunity to choose the meaningful, positive way to live. Because for human beings, our physiological and safety needs are the fundamental needs that each person have to fulfill, they are our basic needs FIG. 1.

We human beings are born to create and to thrive. By fulfilling our basic needs, we can help humanity to elevate to higher grounds.

The the scope of the invention is wide, more than any single entity can handle or implement. This invention and the knowledge that it is based on is written here so that they are preserved and shared, benefiting the people in this world.

What is claimed is:

1. A data processing system for managing a crowd sourced peer custom design service group, packaging resources as granular transient data packages and regularly distributing said granular resources to said plurality of service providers, comprising:
a. a computer processor means for processing data;
b. storage means for storing data on a storage medium; and
c. means for said computer processor to keep track of time and maintain timeframes;
d. means for ration and packaging granular resources into data packages; and
e. means for adding timestamp and metadata to said data packages; and
f. means for said system automatically distributing a plurality of said data packages within a timeframe; make said data packages valid and ready for use within said timeframe, expire at the end of said timeframe; and
g. Means for said system to reset and start new timeframe immediately after previous timeframe ends, automatically distribute a plurality of new data packages in said new timeframe; and
h. means for storing said distribution data on said storage medium, manage said distribution to ensure that one user can not receive more data packages than what he/she can consume within said timeframe; and
i. means for processing data and allow a user to receive new package upon consuming previously received package within said timeframe; and
j. means for automatically reset the data processing unit, regularly perform said granular distribution for each timeframe; and
k. means for sharing said distribution and ownership of said data packages with other data processing system through blockchain system.

2. A process of operating a data processor to regularly distributing granular transient resources to a plurality of users of a peer custom design group using timeframes, such that any user can immediately receive said resource package upon request, comprising the steps of:
a. maintaining a timer in a storage area of said data processor to keep track of time and maintain timeframes;
b. packaging granular resources into data packages using said data processor; and
c. adding timestamp and metadata to said data packages, make valid and ready for use within said timeframe, expire at the end of said timeframe; and
d. distributing plurality of data packages to said plurality of users in said timeframe; and
e. recording the distribution of said resource package, ensure one user can not receive more than what he/she can consume within said timeframe; and
f. refreshing and reset data processor at the end of each timeframe, immediate start a new timeframe after the previous timeframe ends; and
g. repeating steps a to f to continuously and automatically distributing granular transient resources to said plurality of users in each timeframe.

3. A process of operating a data processor to regularly distributing granular per diem work time tokens to a plurality of users of a peer custom design group using timeframes, automatically redeem tokens and issue rewards to an user upon said user completing work, comprising the steps of:
a. maintaining a timer in a storage area of said data processor to keep track of time and maintain timeframes;
b. packaging work time tokens into data packages using said data processor; and
c. adding timestamp and metadata to said data packages, make valid and ready for use within said timeframe, expire at the end of said timeframe; and
d. distributing plurality of data packages to said plurality of users in said timeframe; and
e. storing said distribution data on said storage medium, ensure one user can not occupied more packages than he/she can use in said timeframe; and
f. verifying completed work automatically, redeeming said work time token and reward user upon said user reporting completion of work; and
g. refreshing and reset data processor at the end of each timeframe, immediate start a new timeframe after the previous timeframe ends; and
h. repeating steps a to g to continuously and automatically distributing granular per diem work time tokens to said plurality of users in each timeframe.
